(19) United States
(12) Patent Application Publication
(10) Pub. No.: US 2016/0068032 A1
(43) Pub. Date: Mar. 10, 2016

(54) Tire Shield Attachment System

(71) Applicants: David Kritzell, Doylestown, PA (US); Christopher R. Renson, Langhorn, PA (US); Olivier Marsaly, Princeton, NJ (US); Lars Johan Resare, Ewing, NJ (US); Christopher Golon, Lebanon, NJ (US)

(72) Inventors: David Kritzell, Doylestown, PA (US); Christopher R. Renson, Langhorn, PA (US); Olivier Marsaly, Princeton, NJ (US); Lars Johan Resare, Ewing, NJ (US); Christopher Golon, Lebanon, NJ (US)

(73) Assignee: Hutchinson, SA

(21) Appl. No.: 14/477,322

(22) Filed: Sep. 4, 2014

(51) Int. Cl. B60C 19/12

(52) U.S. Cl. CPC B60C 19/125

(57) ABSTRACT

This tire shield attachment system uses flexible connectors including chains, mesh, webbings, connectors, cables or the like to hold the protective shield in position adjacent the sidewall. The connectors cross over the treaded part of the tire and may be placed through gaps between the treads or over the treads of the tire being protected. The connectors are attached on the inboard side to an inboard attachment ring, and on the outboard side to the tire shield directly or to an outboard ring to which the shield may be mounted. The inboard ring can be opened for installation around the axle without removing the wheel. The tire shield may, in most embodiments, also be removed or changed out without removing the attachment system. Both inboard and outboard rings may be formed from flexible or rigid materials and may have elastic properties and/or incorporate tensioning devices. The same is true for the connectors, which may be placed over or under the tire shield.

### CROSS-REFERENCE TO RELATED APPLICATIONS

This application claims an invention which was disclosed in a provisional application filed Sep. 4, 2013, Ser. No. 61/873,742, entitled “Tire Shield Attachment System”. The benefit under 35 USC §119(e) of the United States provisional application is hereby claimed, and the aforementioned application is hereby incorporated herein by reference.

### BACKGROUND AND SUMMARY

This invention pertains generally to systems for attachment of a tire protection device or shield to a tire and/or wheel for use, primarily, with construction equipment. A tire protection device generally takes the form of a covering applied to the exterior surface of a tire and is used to prevent or mitigate damage to the tire used in vehicle operation. The types of damage that construction equipment tires are typically subjected to include, but are not limited to, cuts from rough terrain, sabotage, aberration and obstacles. Methodologies for sidewall and tread protection have been covered in numerous U.S. patents. Representative examples of these patents include: U.S. Pat. No. 235,251 for “Sidewall Protector,” issued Mar. 6, 1915; U.S. Pat. No. 1,867,518 for “Mud Guard,” issued Apr. 10, 1928; U.S. Pat. No. 1,905,674 for “Splash Protector,” issued Jan. 2, 1931; U.S. Pat. No. 2,017,891 for “Skip Preventer,” issued Aug. 11, 1933; U.S. Pat. No. 2,334,388 for “Ornamental Sidewall,” issued Nov. 12, 1941; U.S. Pat. No. 3,187,797 for “Water Deflecting Sidewall,” issued Nov. 27, 1963: U.S. Pat. No. 3,811,488 for “Tread & Sidewall Protector,” issued Apr. 3, 1989; U.S. Pat. No. 4,030,530 for “Removable Tread,” issued Sep. 26, 1991; U.S. Pat. No. 4,111,250 for “Removable Tread,” issued Nov. 19, 1986; U.S. Pat. No. 4,235,271 for “Sidewall Protector,” issued Jul. 13, 1979; and U.S. Pat. No. 4,319,618 for “Sidewall Protector,” issued Apr. 28, 1980.

However, while all of the aforesaid prior devices and methods exist to protect certain aspects of the tire, all have disadvantages. First, the protection device(s) described that are compressed between the wheel flange and the tire bead may cause excessive wear on the tire bead. Second, the protection device(s) described with excessive or inaccessible hardware cannot be easily assembled or disassembled from the wheel/tire assembly. Third, in all cases, the protection device(s) described must be removed in order for the tire to be replaced.

The instant invention resolves and avoids most of these difficulties using novel attachment methodologies. However, all depend to some degree on the use of flexible connectors such as webbing, mesh, chains, cables, straps, combinations of the foregoing or the like that “bridge” the tire treads to apply tension and otherwise hold the protective shield in position adjacent the sidewall of a tire. In the preferred schematic embodiments illustrated, straps are generally shown as “connectors” for ease of illustration; however, it should be understood that such straps, though advantageous and preferred for a variety of uses, also schematically represent a variety of other possible connectors such as those listed above. Likewise, the straps/cables illustrated are generally shown passing through gaps between the treads of the tire being protected, but may also pass over the treads.

The foregoing innovations result in numerous advantages. First, these methods for attachment of a protection device to a wheel/tire assembly are more versatile and robust. Second, these attachment methods for a protection device are simplified and require less time to assemble and disassemble. Third, these attachment methods for a protection device are simplified and require fewer parts to affix the device to the wheel/tire assembly. Fourth, these attachment methods can be used on any type of road wheel including, but not limited to, single and multi-piece wheels. Fifth, the mode of attachment for the protection device can include isolation methods that can prevent or mitigate damage to the wheel/tire assembly from impact or other dynamic shocks experienced during vehicle operation. Sixth, these attachment methods allow for lateral and radial tire and/or wheel flexing at various operating pressures. The numerous other advantages of our invention will become more apparent in view of the more detailed description and claims that follow.

### BRIEF DESCRIPTION OF THE DRAWINGS

FIG. 1 provides a perspective schematic exploded view illustrating a protection shield attachment system in the process of and/or as it would be, attached to a wheel/tire assembly by means of connectors in the form of tire wrapping straps. This embodiment of the invention includes and utilizes a solid inboard ring to which the tire wrapping connection straps are attached.

FIG. 2 provides a perspective schematic exploded view illustrating an alternate embodiment of a protection shield attachment system in the process of and/or as it would be, attached to a wheel/tire assembly by means of connectors in the form of tire wrapping connection straps. This embodiment of the invention includes and utilizes a split inboard ring to which the tire wrapping connection straps are attached.

FIG. 3 provides a schematic perspective view illustrating how the connectors in the form of connection straps can be nested between tire treads (or lugs) in accordance with the teachings of the invention.

FIG. 4 provides a schematic cross-sectional view illustrating the protection shield attachment system of FIGS. 1 through 3 after attachment to a wheel/tire assembly by means of its connectors in the form of tire wrapping connection straps.

FIG. 5 provides a perspective schematic exploded view illustrating another alternate embodiment of a protection shield attachment system in the process of and/or as it would be, attached to a wheel/tire assembly by means of connectors in the form of tire wrapping connection straps. This embodiment of the invention includes and utilizes a flexible/strap based inboard “ring” to which the tire wrapping connection straps are attached.

FIG. 6 provides a perspective schematic view illustrating the protection shield attachment system of FIG. 5 from the inboard side after attachment to a wheel/tire assembly by means of its connectors in the form of tire wrapping connection straps.

FIG. 7 provides a schematic cross-sectional view illustrating an alternate embodiment of the protection shield attachment system wherein the connectors in the form of straps run outboard of the tire shield after attachment to a wheel/ire assembly by means of said tire wrapping connection straps.

FIG. 8 provides a schematic cross-sectional view illustrating an alternate embodiment of the protection shield attachment system wherein a tensioning element arrangement is used to tighten/tension the connectors/straps where they terminate and anchor to an outboard adapter ring of the type illustrated in FIGS. 1 through 6.

FIG. 9 provides a schematic cross-sectional view illustrating an alternate embodiment of the protection shield attachment system wherein the connectors/straps of the invention are anchored to the tire shield close to the outer diameter/edge thereof.

FIG. 10 provides a schematic perspective cross-sectional and somewhat exploded view illustrating the alternate embodiment of the protection shield attachment system of the invention shown in FIG. 10 and furthering illustrating the anchor points for the connectors in the form of straps.

FIGS. 11A and 11B provide schematic perspective views illustrating how connectors in the form of straps or chains can also run across/over the tire treads (or lugs) in accordance with the teachings of the invention.

### DESCRIPTION

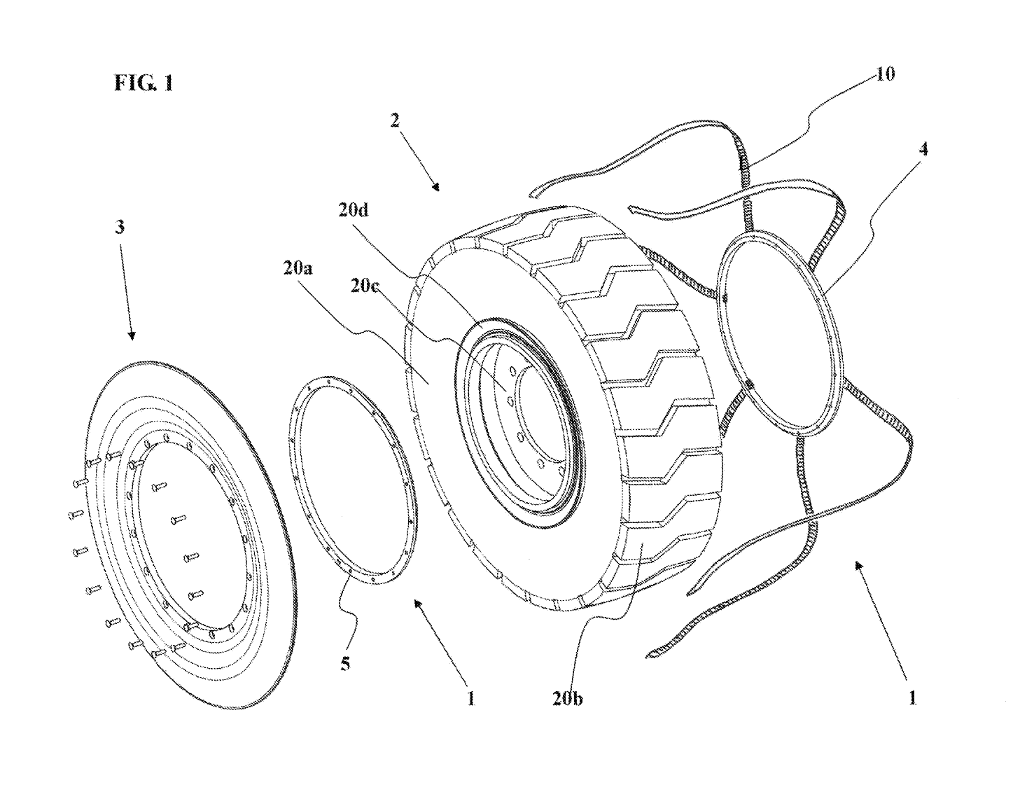

The first preferred embodiment of the inventive concept is illustrated in FIG. 1. As illustrated in FIG. 1, the protection shield attachment system of this embodiment (denoted generally by arrows 1) is in the process of being, and/or as it would be used to, attach a tire protection shield (denoted generally by arrow 3) to a wheel/tire assembly (denoted generally by arrow 2) by means of tire wrapping connectors in the form of straps 10. The wheel/tire assembly 2 features a tire 20 having an outer sidewall 20a and treads 20b which is mounted on a rim 20c having flanges 20d. As will be noted from this embodiment, the primary elements of the invention are an outboard ring 5 (which is formed by the tire shield 3 itself in some embodiments) linked by connectors in the form of straps 10 (or other connecting webbing or linkage) across the treads 20b of tire 20 to an inboard ring 4 (which may also take a variety of forms). Rings 4, 5 for this embodiment can advantageously be formed from metal or rigid composite materials. As previously mentioned, the connectors 10 may take a variety of forms; thus, the term “strap” is intended to cover a variety of different connective structures including those comprised of high durability composite fiber materials, metals, composite webbing or wire materials and/or links/chains. However, all suitable materials and structures for straps 10 are characterized by flexibility and durability. Other preferred useful variations and alternate embodiments are explored in subsequent figures and accompanying discussion.

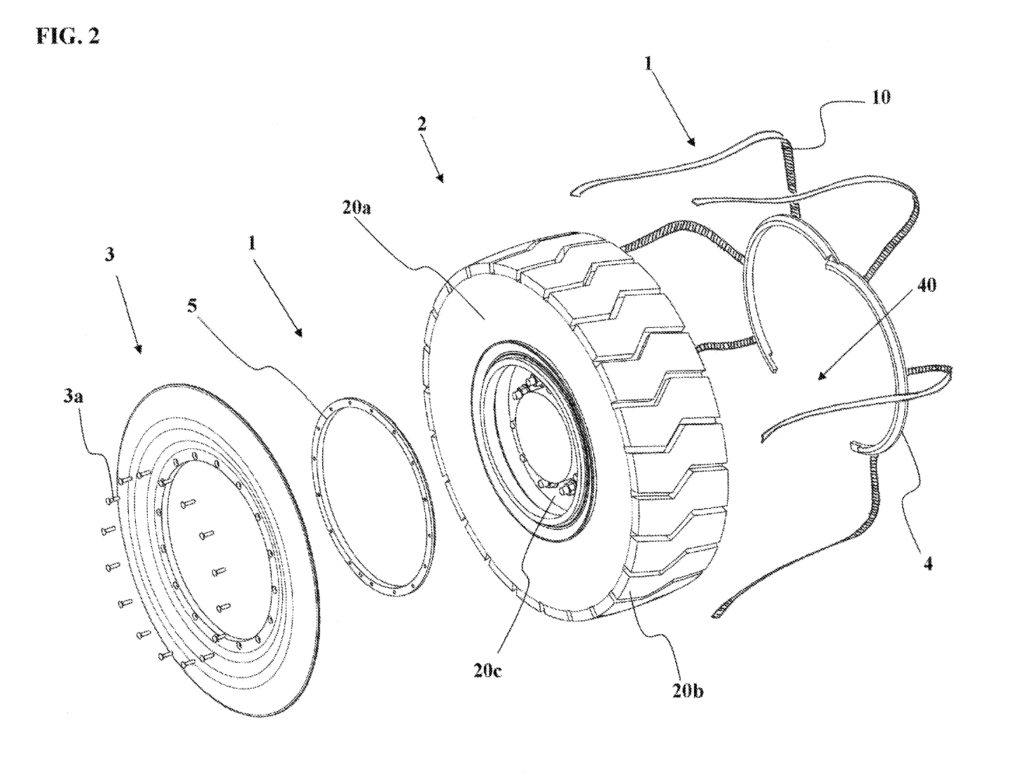

The embodiment of the invention illustrated in FIG. 1 includes and utilizes a solid inboard ring 4 as well as a solid outboard ring 5 to which the tire wrapping connectors 10 are attached to hold the tire shield 3 (which is connected to the outboard ring 5 via threaded connectors 3a) in position adjacent the sidewall 20a of wheel assembly 2. In contrast to this, FIG. 2 illustrates a first alternate embodiment of a protection shield 3 attachment system 1 in the process of and/or as it would be, attached to a wheel/tire assembly 2 by means of its tire wrapping connectors 10. This embodiment of the invention includes and utilizes a split inboard ring 4a to which the tire wrapping connectors in the form of connection straps 10 are attached. In the embodiment illustrated, split inboard ring 4a features two halves which may be opened to create a gap (as denoted generally by arrow 40) so as to allow placement around a wheel axle 70 and then fastened together again via suitable mechanical fasteners thereby allowing mounting of the system 1 without demounting the wheel 2. After split ring 4a is closed around the axle on the inboard side of wheel 2, straps 10 can be wrapped over the tire and tightened and secured to the outboard mounting ring 5. The tire shield 10 can then be attached to the outboard ring 5 via e.g., screws 3a as shown.

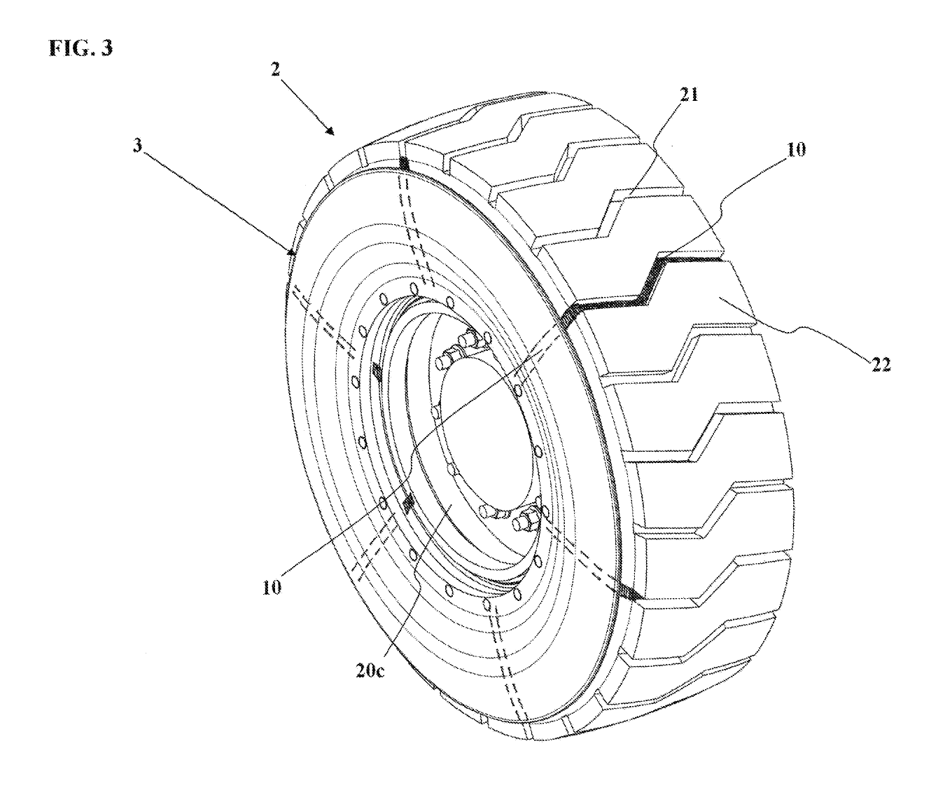

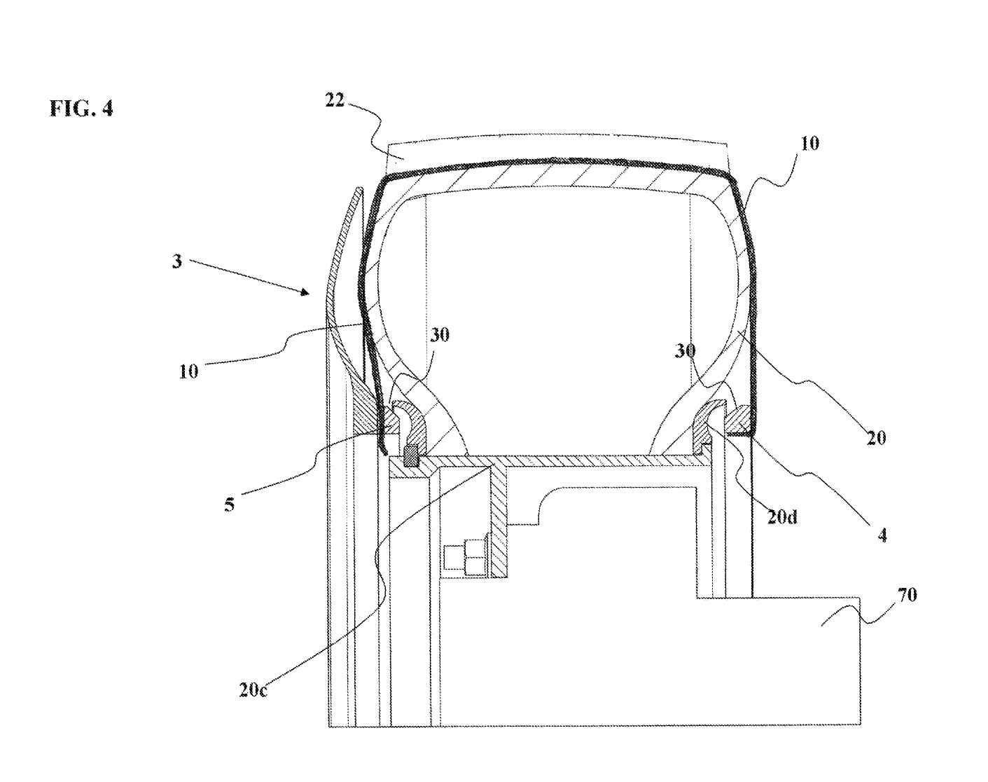

FIGS. 3 and 4 provide further insight into the first two embodiments. FIG. 3 provides a perspective view illustrating schematically how the connectors/straps 10 of the protection shield attachment system 1 of FIGS. 1 and 2 are nested in the grooves 21 between tire tread “lugs” (or elevated portions) 22 in accordance with the teachings of the invention, and thereby protected from direct ground contact and excessive wear and tear. FIG. 4 provides a schematic cross-sectional view of the aforesaid embodiments after attachment to the wheel/tire assembly 2. As will be noted, though the attachment system 1 is held in place primarily by means of its tire wrapping connection connectors/straps 10, it is also assisted in these embodiments (as in most others shown) in assuming and maintaining its position by the interaction between its rings 4, 5 and flanges 20d of rim 20c. The piloting function of rings 4, 5 is also enhanced by the inclusion of chamfer features 30 adjacent wheel flanges 20d as illustrated.

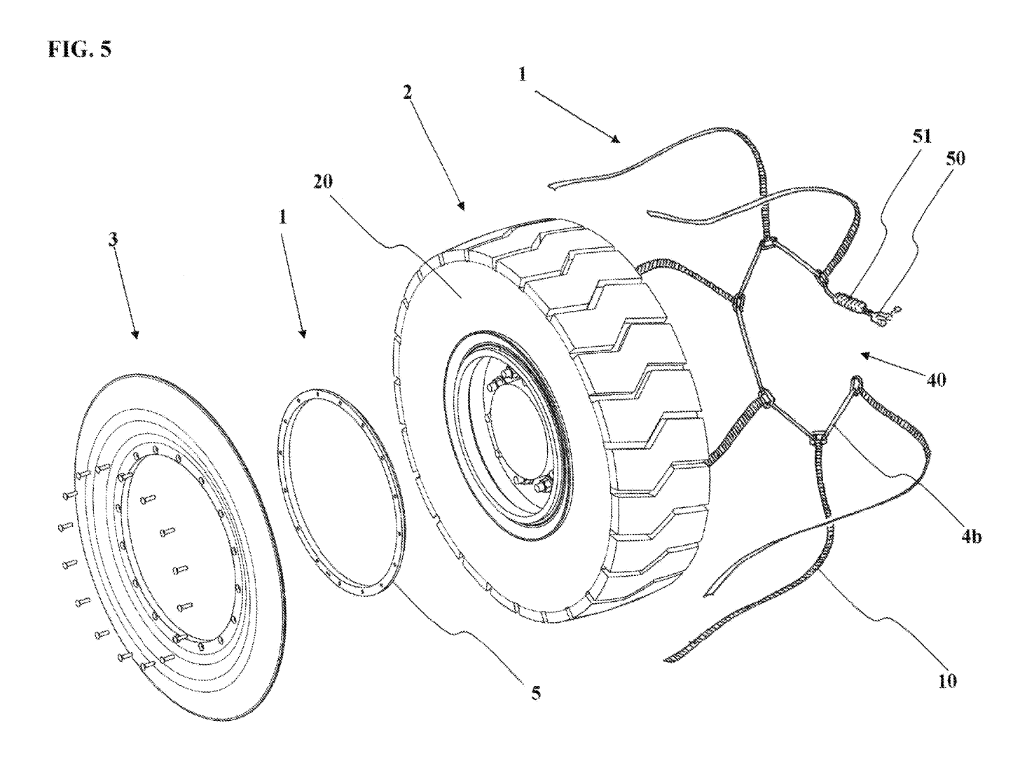

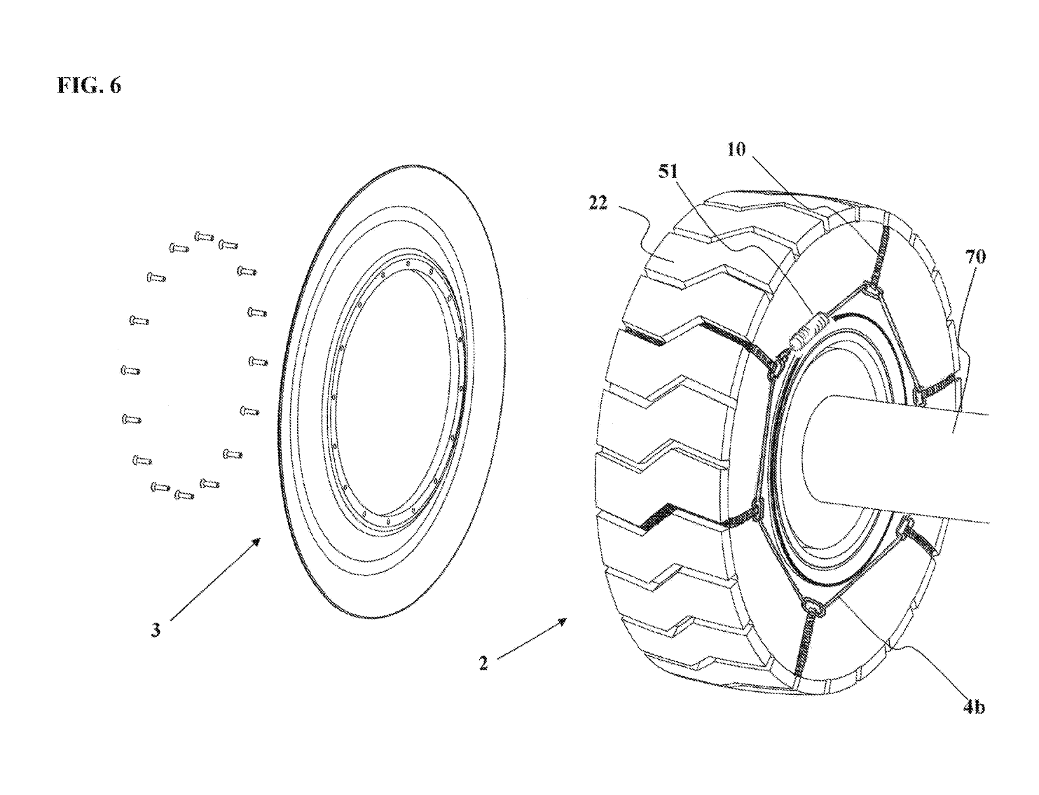

FIGS. 5 and 6 introduce another embodiment of the system 1 in the process of, and/or as it would be, attached to a wheel/tire assembly 2 by means of tire wrapping connectors in the form of connection straps 10. This embodiment includes and utilizes a flexible/strap based inboard “ring” 4b to which the tire wrapping connection straps 10 are attached. However, as in the prior embodiment, ring 4b can be opened/closed via a refastenable fastener 50 allowing system 1 to be placed on a wheel 2 without demounting the wheel 2. As will be noted, this embodiment also includes a spring actuated tensioning element 51 as part of ring 4b. (Alternately, ring 4b might be constructed of elastic materials in order to accomplish the same purpose). Such tensioning and/or tightening elements and materials can, depending on position and utility, take a variety of forms well known in the mechanical arts, such as elastic materials, springs, lockable turnbuckles, ratchet mechanisms and the like. All such elements and devices aid in keeping the assembly 1 and its subparts snugly in position on wheel assembly 2.

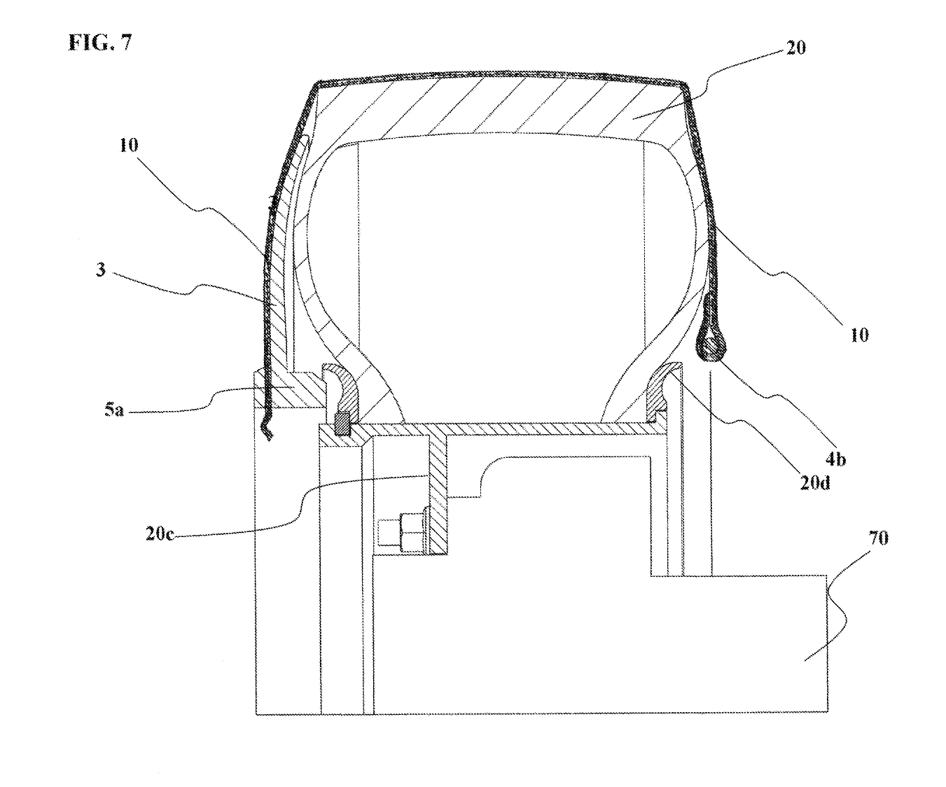

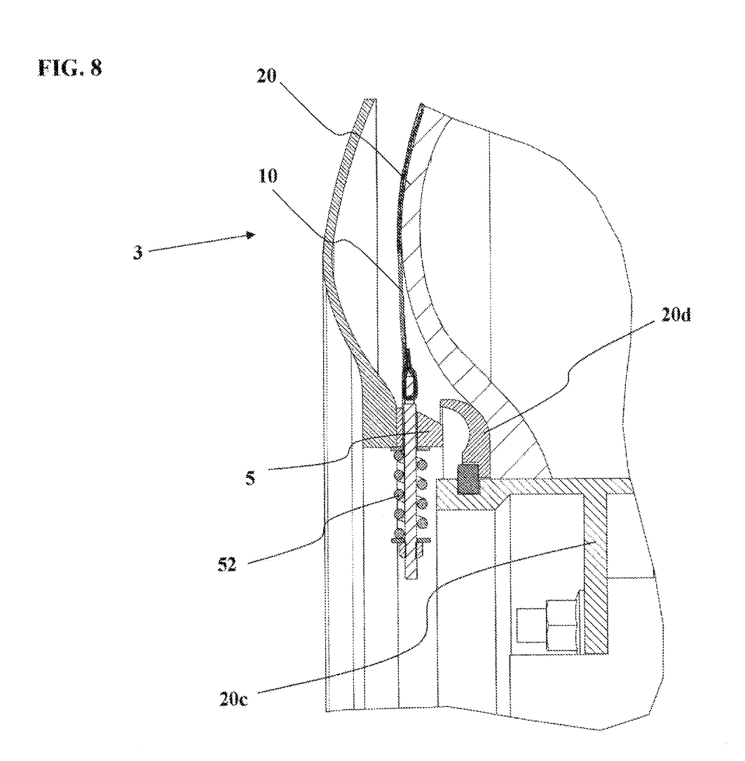

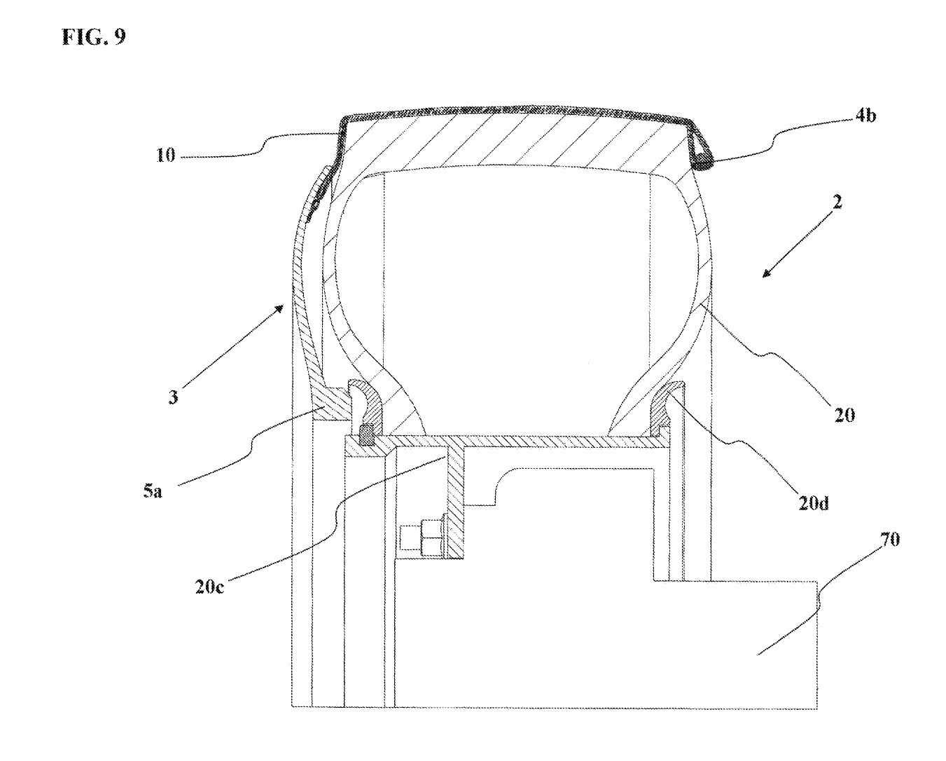

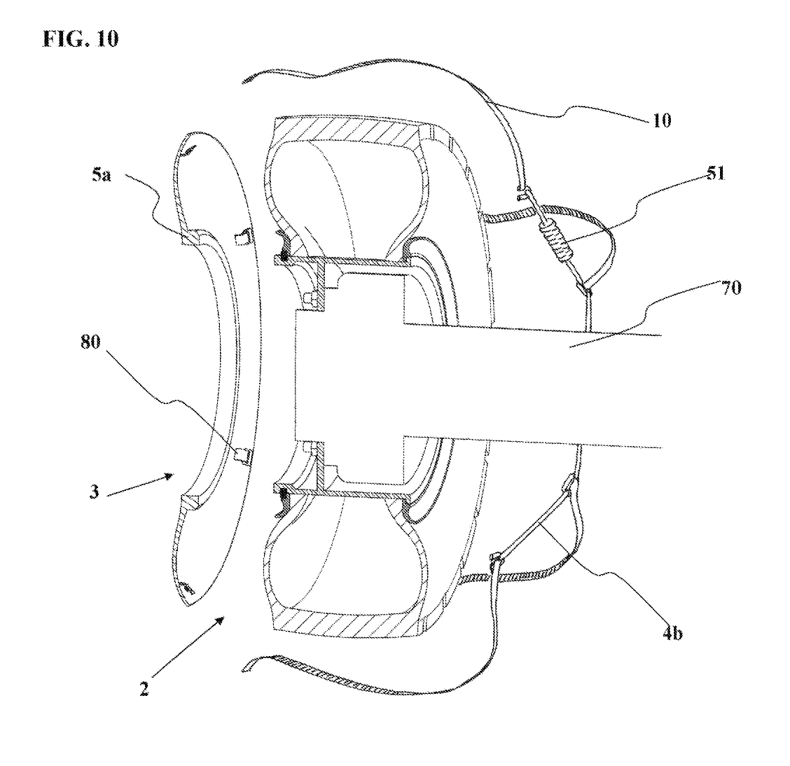

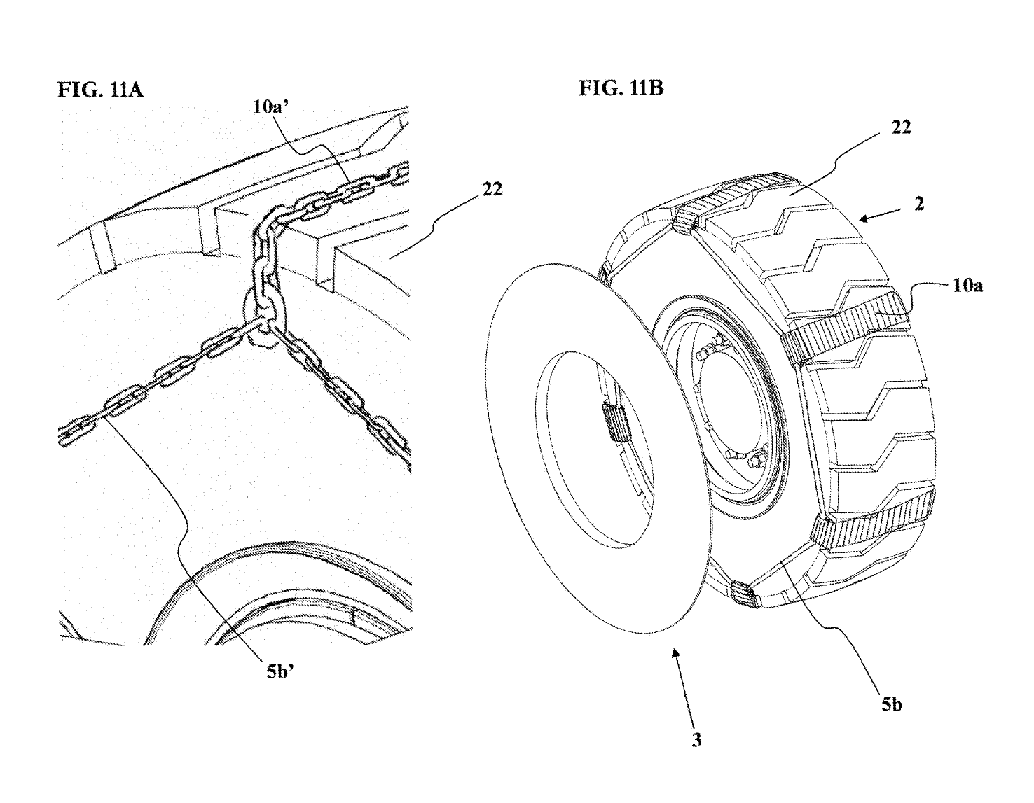

FIGS. 7 through 11 illustrate other notable variations, and/or embodiments, of the invention. For example, FIG. 7 illustrates an embodiment in which connectors/straps 10 run outboard of the tire shield 3. (It should also be noted that in this embodiment the outboard ring 5a is formed as part of the tire shield 3). FIG. 8 illustrates an embodiment where a spring actuated tensioning element 52 is intermediate and engaging outboard ring 5 and cross strap 3 to tension and tighten the strap 3 of the invention and better hold the assembly 1 firmly in position on tire assembly 2. (Once again, as with rings 4, 5 and their variations, tension can also be provided by forming strap 3 from elastic materials). FIGS. 9 and 10 illustrate an embodiment where strap 10 connects to the top of the tire shield 3, and inboard ring 4b is positioned much closer to the outer diameter of tire 20. In this embodiment, the fasteners 80 linking straps 10 and tire shield 3 are non-permanent clamps or other mechanical strap fasteners. This allows the straps 10 to be pulled tight before fastening as well as easy replacement of any or all of straps 10 due to wear or breakage. Finally, FIGS. 11A and 11B illustrates embodiments where connectors in the form of straps 10a or chains 10a′ can be routed across the tire tread lugs 22 rather than between tread lugs 22 as previously illustrated. (Similarly to a snow chain (and prior embodiments), the system of straps 10a and chains 10a′ used in these embodiments are linked together on both inboard and outboard sides). These embodiments also illustrate the use of a flexible outboard rings 5b and 5b′ to which the tire shield 3 may be fastened.

As previously noted, the material used for connectors such as straps 10a and chains 10a′ can be anything ranging from a flexible strap material to heavy-duty steel chains, cables and/or webbing. Likewise, connectors 10 normally intended for fastening between tire lugs may be unable to be fastened in this manner and should, therefore, be made of sturdy and durable material capable of sustaining heavy usage and direct contact between tire 20 and relevant supporting surfaces, such as gravel, asphalt and other typical roadway materials. Alternately, whether placement of connectors 10 over treads 22 is intended or unintended, a harder metal sleeve can be provided for the connectors 10 where they pass across treads 22 to provide additional durability and wear.

The described advantages and features of the invention are advantageously provided through and using the preferred embodiments previously illustrated and discussed. However, numerous variations are possible without deviating from and/or exceeding the spirit and scope of the invention. For example, various features and functions disclosed above, or alternatives thereof, may be desirably combined in ways other than those shown in the particular embodiments shown and discussed and into many other different systems or applications. Moreover, various presently unforeseen or unanticipated alternatives, modifications, variations or improvements therein may be subsequently made by those skilled in the art which are also intended to be encompassed by the claims.

1. A tire shield attachment system for attachment of a tire shield adjacent a tire sidewall where said tire is mounted on a wheel, comprising:
an inboard attachment ring adapted to lie adjacent an inboard side of said wheel or tire;
connectors intermediate and connecting said inboard attachment ring and said tire shield, which connectors cross the treaded portion of said tire; and
wherein said connectors at least one of pass over tread lugs of said tire, and pass between tread lugs of said tire.

2. The system of claim 1, further comprising at least one of
an outboard attachment ring intermediate and connecting said connectors and said tire shield,
an outboard attachment ring connecting said connectors and said tire shield is formed as part of said tire shield,
an attachment ring has a fastenable opening allowing it to be placed around an axle when opened and then fastened to form a closed ring,
an attachment ring is sized and adapted to lie within the rim flanges of the wheel and maintain its position there via a positioning pilot feature, and
an attachment ring is formed from at least one of a rigid material, a flexible material, and an elastic material, and
said connectors are formed from at least one of a flexible material, and an elastic material

3. The system of claim 1, wherein at least one of
a tensioning or tightening element is connected to an attachment ring for tightening or tensioning said attachment ring, and
a tensioning or tightening element is connected to a connector for tensioning or tightening said connector.

4. The system of claim 2, wherein at least one of
a tensioning or tightening element is connected to an attachment ring for tightening or tensioning said attachment ring, and
a tensioning or tightening element is connected to a connector for tensioning or tightening said connector.

5. The system of claim 1, wherein at least one of
said connectors connect to a portion of said tire shield proximate the tire treads,
said connectors connect to a portion of said tire shield proximate said wheel rim,
said connectors are removably connected to said tire shield,
said connectors run outboard of and across said tire shield, and
said connectors run intermediate said tire shield and the tire sidewall.

6. The system of claim 2, wherein at least one of
said connectors connect to a portion of said tire shield proximate the tire treads,
said connectors connect to a portion of said tire shield proximate said wheel rim,
said connectors are removably connected to said tire shield,
said connectors run outboard of and across said tire shield, and
said connectors run intermediate said tire shield and the tire sidewall.

7. The system of claim 3, wherein at least one of
said connectors connect to a portion of said tire shield proximate the tire treads,
said connectors connect to a portion of said tire shield proximate said wheel rim,
said connectors are removably connected to said tire shield,
said connectors run outboard of and across said tire shield, and
said connectors run intermediate said tire shield and the tire sidewall.

8. The system of claim 4, wherein at least one of
said connectors connect to a portion of said tire shield proximate the tire treads,
said connectors connect to a portion of said tire shield proximate said wheel rim,
said connectors are removably connected to said tire shield,
said connectors run outboard of and across said tire shield, and
said connectors run intermediate said tire shield and the tire sidewall.

9. A tire shield system for attachment adjacent a tire sidewall of a tire mounted on a wheel, comprising:
a tire shield shaped and adapted to lie adjacent an outboard tire sidewall; and
a tire shield attachment system for attachment of said tire shield adjacent a tire sidewall of a tire mounted on a wheel, comprising
an inboard attachment ring adapted to lie adjacent an inboard side of said wheel or tire,
connectors intermediate and connecting said inboard attachment ring and said tire shield, which connectors cross the treaded portion of said tire, and
wherein said connectors at least one of pass over tread lugs of said tire, and pass between tread lugs of said tire.

10. The system of claim 9, wherein at least one of
said attachment system further comprises an outboard attachment ring intermediate and connecting said connectors and said tire shield,
said attachment system further comprises an outboard attachment ring connecting said connectors and said tire shield which is formed as part of said tire shield,
an attachment ring has a fastenable opening allowing it to be placed around an axle when opened and then fastened to form a closed ring,
an attachment ring is sized and adapted to lie within the rim flanges of the wheel and maintain its position there via a positioning pilot feature,
an attachment ring is formed from at least one of a rigid material, a flexible material, and an elastic material,
said connectors are formed from at least one of a flexible material, and an elastic material,
a tensioning or tightening element is connected to an attachment ring for tightening or tensioning said attachment ring, and
a tensioning or tightening element is connected to a cross-strap for tensioning or tightening said cross-strap.

11. The system of claim 9, wherein at least one of
said connectors connect to a portion of said tire shield proximate the tire treads,
said connectors connect to a portion of said tire shield proximate said wheel rim,
said connectors are removably connected to said tire shield,
said connectors run outboard of and across said tire shield, and
said connectors run intermediate said tire shield and the tire sidewall.

12. The system of claim 10, wherein at least one of
said connectors connect to a portion of said tire shield proximate the tire treads,
said connectors connect to a portion of said tire shield proximate said wheel rim,
said connectors are removably connected to said tire shield,
said connectors run outboard of and across said tire shield, and
said connectors run intermediate said tire shield and the tire sidewall.

13. A method for attaching a tire shield a tire sidewall of a tire mounted on a wheel, comprising:
producing a tire shield shaped and adapted to lie adjacent an outboard tire sidewall and a tire shield attachment system for attachment of said tire shield adjacent a tire sidewall of a tire mounted on a wheel, where said attachment system comprises
an inboard attachment ring adapted to lie adjacent an inboard side of said wheel or tire,
connectors intermediate and connecting said inboard attachment ring and said tire shield, which connectors cross the treaded portion of said tire, and
wherein said connectors at least one of pass over tread lugs of said tire, and pass between tread lugs of said tire; and
disposing said inboard attachment ring around said rim on the inboard side of said tire, said connectors across said tire treads passing over or between said tire lugs, and said tire shield around said rim on the outboard side of said tire adjacent said tire sidewall.

14. The method of claim 13, wherein at least one of
said attachment system further comprises an outboard attachment ring intermediate and connecting said connectors and said tire shield,
said attachment system further comprises an outboard attachment ring connecting said connectors and said tire shield which is formed as part of said tire shield,
an attachment ring has a fastenable opening allowing it to be placed around an axle when opened and then fastened to form a closed ring,
an attachment ring is sized and adapted to lie within the rim flanges of the wheel and maintain its position there via a positioning pilot feature,
an attachment ring is formed from at least one of a rigid material, a flexible material, and an elastic material,
said connectors are formed from at least one of a flexible material, and an elastic material,
a tensioning or tightening element is connected to an attachment ring for tightening or tensioning said attachment ring, and
a tensioning or tightening element is connected to a cross-strap for tensioning or tightening said cross-strap.

15. The method of claim 13, wherein at least one of
said connectors connect to a portion of said tire shield proximate the tire treads,
said connectors connect to a portion of said tire shield proximate said wheel rim,
said connectors are removably connected to said tire shield,
said connectors run outboard of and across said tire shield, and
said connectors run intermediate said tire shield and the tire sidewall.

16. The method of claim 14, wherein at least one of
said connectors connect to a portion of said tire shield proximate the tire treads,
said connectors connect to a portion of said tire shield proximate said wheel rim,
said connectors are removably connected to said tire shield,
said connectors run outboard of and across said tire shield, and
said connectors run intermediate said tire shield and the tire sidewall.

17. The method of claim 14, further comprising
opening said inboard attachment ring and placing it around an axle connected to said rim on the inboard side of said tire; and
closing said inboard attachment ring in place around the rim of said tire.

18. The method of claim 15, further comprising
opening said inboard attachment ring and placing it around an axle connected to said rim on the inboard side of said tire; and
closing said inboard attachment ring in place around the rim of said tire.

19. The method of claim 16, further comprising
opening said inboard attachment ring and placing it around an axle connected to said rim on the inboard side of said tire; and
closing said inboard attachment ring in place around the rim of said tire.
